(19) United States
(12) Patent Application Publication
(10) Pub. No.: US 2026/0177744 A1
(43) Pub. Date: Jun. 25, 2026

(54) LIGHT DETECTOR STRUCTURE, MANUFACTURING METHOD THEREOF, AND OPTICAL INTERCONNECT DEVICE INCLUDING LIGHT DETECTOR STRUCTURE

(71) Applicant: SAMSUNG ELECTRONICS CO., LTD., Suwon-si (KR)

(72) Inventors: Youngzoon YOON, Suwon-si (KR); Chanwook BAIK, Suwon-si (KR); Kyungsang CHO, Suwon-si (KR)

(73) Assignee: SAMSUNG ELECTRONICS CO., LTD., Suwon-si (KR)

(21) Appl. No.: 19/244,264

(22) Filed: Jun. 20, 2025

(30) Foreign Application Priority Data
Dec. 23, 2024 (KR) 10-2024-0194654

(51) Int. Cl. G02B 6/12; G01J 1/04; G02B 6/13; G02B 6/293

(52) U.S. Cl. CPC G02B 6/12007; G01J 1/0407; G02B 6/13; G02B 2006/12138; G02B 6/29343

(57) ABSTRACT

Provided is a light detector structure including a first waveguide configured to transmit an optical signal, a second waveguide spaced apart from the first waveguide, a first resonator between a first side of the first waveguide and a first side of the second waveguide, the first resonator having a ring shape and a first diameter, and a second resonator on a second side of the second waveguide opposite to the first side of the second waveguide, the second resonator having a second diameter which is less than the first diameter, wherein the second waveguide is between the first resonator and the second resonator, and wherein the second resonator includes a non-ring-type resonator.

### CROSS-REFERENCE TO RELATED APPLICATION

This application claims priority to Korean Patent Application No. 10-2024-0194654, filed on Dec. 23, 2024, in the Korean Intellectual Property Office, the disclosure of which is incorporated by reference herein in its entirety.

### BACKGROUND

### 1. Field

Embodiments of the present disclosure relate to a light detector structure used for optical signal detection, and more particularly, to a light detector structure in optical interconnect, a manufacturing method thereof, and an optical interconnect device including the light detector structure.

### 2. Description of Related Art

In tandem with the emergence of new industry fields such as artificial intelligence, virtual reality, autonomous robots, etc., transmitting and processing relatively large-scale data more quickly and accurately is being required. Accordingly, there has been a growing interest in silicon-based photonics technologies, and development of such technologies has been accelerated.

Optical interconnect of silicon photonics may include a light source, an optical modulator, a transmitter, and a receiver, and the light source has been developed to increase a volume of transmission data by multi-channel light emission.

In the optical interconnect, separation and obtainment of multiple channel signals may be linked to characteristics of micro resonators. Thus, a wavelength band of light that may be used for data transmission in optical interconnect may be determined according to a diameter of a micro resonator and a refractive index of materials thereof.

The refractive index and diameter of the micro resonator determines a free spectral range (FSR) of the micro resonator, and the Q value which is related to the wavelength selectivity of the micro resonator tends to be inversely proportional to the size of the FSR. That is, when the FSR increases, the Q value decreases, and vice versa. Therefore, in a single resonator structure, extension of a wavelength band may be limited.

### SUMMARY

One or more embodiments provide a light detector structure of an optical interconnect device, which is configured to receive a light signal (wavelength) of a wideband.

One or more embodiments also provide a light detector structure of an optical interconnect device, which is configured to more accurately select a required wavelength from a received optical signal by increasing a Q value related to wavelength selectivity.

One or more embodiments also provide a manufacturing method of the light detector structure described above.

One or more embodiments also provide an optical interconnect device including the light detector structure described above.

Additional aspects will be set forth in part in the description which follows and, in part, will be apparent from the description, or may be learned by practice of embodiments of the disclosure.

According to an aspect of one or more embodiments, there is provided a light detector structure including a first waveguide configured to transmit an optical signal, a second waveguide spaced apart from the first waveguide, a first resonator between a first side of the first waveguide and a first side of the second waveguide, the first resonator having a ring shape and a first diameter, and a second resonator on a second side of the second waveguide opposite to the first side of the second waveguide, the second resonator having a second diameter which is less than the first diameter, wherein the second waveguide is between the first resonator and the second resonator, and wherein the second resonator includes a non-ring-type resonator.

The light detector structure may further include a first resonator array on the second side of the second waveguide, wherein the first resonator array may include a plurality of non-ring-type resonators including the second resonator, and wherein diameters of the plurality of non-ring-type resonators may be different from each other and are less than the first diameter.

The second resonator may include a disk-type resonator.

The second resonator may include a substrate, a first semiconductor layer on the substrate, and a second semiconductor layer on the first semiconductor layer, wherein the first semiconductor layer may include a first doping area, wherein the second semiconductor layer may include a second doping area spaced apart from the first doping area, and wherein an entirety of the second semiconductor layer may be on an area of the first semiconductor layer inside of the first doping area, and a lateral side of the second semiconductor layer may be spaced apart from the first doping area.

The light detector structure may further include a third resonator on a second side of the first waveguide opposite to the first side of the first waveguide, the third resonator having a third diameter which is different from the first diameter and is greater than the second diameter, a third waveguide on the second side of the first waveguide, and a fourth resonator adjacent to the third waveguide and having a fourth diameter which is less than the first diameter and the third diameter and is different from the second diameter, wherein the third resonator may be between the first waveguide and the third waveguide, and wherein the third waveguide may be between the third resonator and the fourth resonator.

A resonator array may be on the fourth resonator of the third waveguide, the resonator array may include a plurality of resonators including the fourth resonator, and diameters of the plurality of resonators may be different from each other and are less than the first diameter and the third diameter.

A first ring-type resonator array may be on the first side of the first waveguide along a length direction of the first waveguide, the first ring-type resonator array may include a plurality of ring-type resonators having diameters that are different from each other and are greater than the second diameter, and a plurality of second waveguides, including the second waveguide, may be in one-to-one correspondence to the plurality of ring-type resonators.

A non-ring-type resonator array may be on the second side of each of the plurality of second waveguides, the non-ring-type resonator array may include a plurality of non-ring-type resonators having a structure same as a structure of the second resonator and diameters that are different from each other and less than the diameters of the plurality of ring-type resonators included in the first ring-type resonator array.

The plurality of second waveguides may be inclined with respect to the first waveguide.

The light detector structure may further include a second ring-type resonator array on a second side of the first waveguide opposite to the first side of the first waveguide, the second ring-type resonator array being along the length direction of the first waveguide, a plurality of third waveguides in one-to-one correspondence to a plurality of ring-type resonators included in the second ring-type resonator array, and a plurality of non-ring-type resonators in correspondence to the plurality of third waveguides, wherein the plurality of ring-type resonators included in the second ring-type resonator array may have diameters that are different from each other, are different from the first diameter, and are greater than the second diameter, wherein the second ring-type resonator array may be between the first waveguide and the plurality of third waveguides, and wherein the plurality of third waveguides may be between the second ring-type resonator array and the plurality of non-ring-type resonators.

Diameters of the plurality of non-ring-type resonators may be different from each other and less than the diameters of the plurality of ring-type resonators included in the second ring-type resonator array.

The plurality of third waveguides may be inclined with respect to the first waveguide.

According to another aspect of one or more embodiments, there is provided a method of manufacturing a light detector structure, the method including forming a first resonator on a substrate, forming a waveguide, configured to transmit an optical signal, spaced apart from the first resonator, and forming a second resonator on the substrate, wherein the first resonator is of a first type and has a first diameter, wherein the second resonator is of a second type and has a second diameter, wherein the first type and the second type are different from each other, wherein the first diameter and the second diameter are different from each other, and wherein the forming of the first resonator and the forming of the second resonator are completed at different time points from each other.

The forming of the waveguide may include forming a first waveguide on the substrate, and forming a second waveguide spaced apart from the first waveguide, wherein the first resonator is formed between the first waveguide and the second waveguide, and wherein the second waveguide is formed between the first resonator and the second resonator.

The method may further include forming a plurality of first resonators, including the first resonator, along the first waveguide, diameters of the plurality of first resonators being different from each other, forming a plurality of second waveguides, including the second waveguide, to correspond to the plurality of first resonators, respectively, and forming a plurality of second resonators, including the second resonator, to correspond to the plurality of second waveguides, respectively, wherein diameters of the plurality of second resonators are different from each other and are less than the diameters of the plurality of first resonators.

The method may further include forming a third waveguide on the substrate, and forming a third resonator on the substrate which is between the first waveguide and the third waveguide, wherein the third resonator is of the first type and has a third diameter which is different from the first diameter and is greater than the second diameter.

The method may further include forming a fourth resonator on the substrate, wherein the fourth resonator is formed such that the third waveguide is between the third resonator and the fourth resonator, and wherein the fourth resonator is of the second type and has a fourth diameter which is different from the second diameter and is less than the first diameter and the third diameter.

The method may further include forming a plurality of third resonators, including the third resonator, along the first waveguide, diameters of the plurality of third resonators being different from each other, forming a plurality of third waveguides, including the third waveguide, to correspond to the plurality of third resonators, respectively, and forming a plurality of fourth resonators, including the fourth resonator, to correspond to the plurality of third waveguides, respectively, wherein diameters of the plurality of fourth resonators may be different from each other and are less than the diameters of the plurality of third resonators.

The forming of the second resonator may include forming a first semiconductor layer on the substrate, forming a first doping area in a first area of the first semiconductor layer, forming a second semiconductor layer in a second area of the first semiconductor layer spaced apart from the first area of the first semiconductor layer, and forming a second doping area in the second semiconductor layer, wherein one of the first doping area and the second doping area may include a P-type dopant, and the other of the first doping area and the second doping area may include an N-type dopant.

According to still another aspect of one or more embodiments, there is provided an optical interconnect device including a light source, a modulator configured to modulate light emitted from the light source, a transmitter configured to transmit the modulated light transmitted from the modulator, a receiver and detector configured to receive and detect the light transmitted from the transmitter, wherein the receiver and detector includes a light detector structure including a first waveguide configured to transmit an optical signal, a second waveguide spaced apart from the first waveguide, a first resonator between a first side of the first waveguide and a first side of the second waveguide, the first resonator having a ring shape and a first diameter, and a second resonator on a second side of the second waveguide opposite to the first side of the second waveguide, the second resonator having a second diameter which is less than the first diameter, and wherein the second waveguide is between the first resonator and the second resonator, and wherein the second resonator includes a disk-type resonator.

### BRIEF DESCRIPTION OF DRAWINGS

The above and other aspects, features, and advantages of embodiments will be more apparent from the following description taken in conjunction with the accompanying drawings, in which:

FIG. 1 is a plan view of a light detector structure of an optical interconnect device according to one or more embodiments;

FIG. 2 is a cross-sectional view of FIG. 1 taken along line 2-2′;

FIG. 3 is a cross-sectional view of FIG. 1 taken along line 3-3′;

FIG. 4 is a plan view illustrating an example of a micro resonator of FIG. 1 in a disk form;

FIG. 5 is a cross-sectional view of FIG. 4 taken along line 5-5′;

FIG. 6 is a plan view illustrating a case in which a plurality of resonators are provided on a side of a second waveguide in a first light detector structure of FIG. 1;

FIG. 7 is a plan view of a second light detector structure of an optical interconnect device according to one or more embodiments;

FIG. 8 is a plan view of a third light detector structure of an optical interconnect device according to one or more embodiments;

FIG. 9 is a plan view of a fourth light detector structure of an optical interconnect device according to one or more embodiments;

FIG. 10 is a plan view of a fifth light detector structure of an optical interconnect device according to one or more embodiments;

FIG. 11 shows a first simulation result for a light detector structure of an optical interconnect device according to one or more embodiments;

FIG. 12 shows a second simulation result for a light detector structure of an optical interconnect device according to one or more embodiments;

FIGS. 13, 14, 15, 16, 17, 18, 19, 20, and 21 are plan views and cross-sectional views illustrating a manufacturing method of a light detector structure of an optical interconnect device according to one or more embodiments; and

FIG. 22 is a block diagram of an optical interconnect device according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, a light detector structure in optical interconnect according to one or more embodiments, a manufacturing method thereof, and an optical interconnect device including the light detector structure are described in detail with reference to the attached drawings. The thickness of layers or areas illustrated in the drawings may be exaggerated for clarity of explanation.

Embodiments described below are provided only as an example, and thus can be embodied in various forms. It will be understood that when a component is referred to as being “on” or “over” another component, the component can be directly on the other component, or can be on the other component in a non-contact manner. Like reference numerals in the drawings denote like members.

An expression used in the singular encompasses the expression of the plural, unless it has a clearly different meaning in the context. When a portion “includes” a component, another component may be further included, rather than excluding the existence of the other component, unless otherwise described.

The use of the terms “a” and “an” and “the” and similar referents in the context of describing embodiments (especially in the context of the following claims) are to be construed to cover both the singular and the plural. The operations of all methods described herein can be performed in any suitable order unless otherwise indicated herein or otherwise clearly contradicted by context. Embodiments are not limited to the described order of the operations.

Moreover, the terms “part,” “module,” etc. refer to a unit processing at least one function or operation, and may be implemented by a hardware, a software, or a combination thereof.

The connecting lines, or connectors shown in the various figures presented are intended to represent exemplary functional relationships and/or physical or logical couplings between the various elements, and thus it should be noted that many alternative or additional functional relationships, physical connections or logical connections may be present in a practical device.

The use of any and all examples, or exemplary language provided herein, is intended merely to better illuminate embodiments and does not pose a limitation on the scope of embodiments unless otherwise claimed.

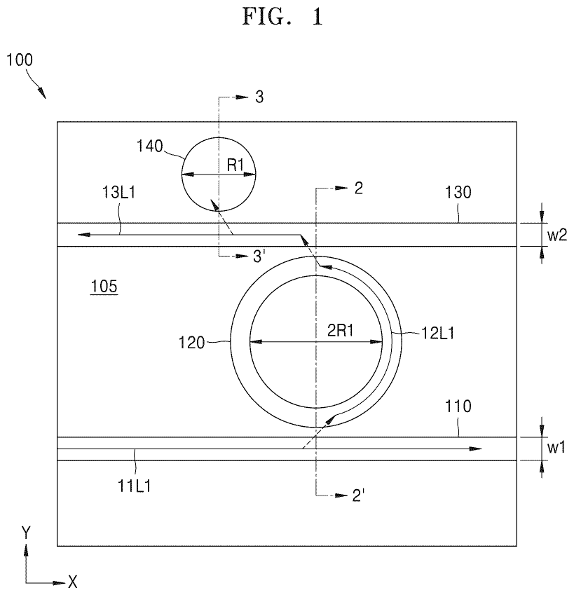

FIG. 1 is a plan view of a first light detector structure 100 in optical interconnect according to one or more embodiments. The first light detector structure 100 may be a part of a receiver unit of an optical interconnect device.

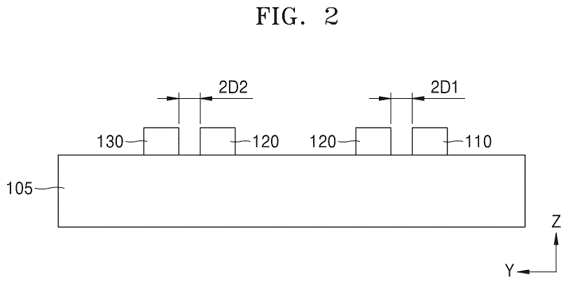

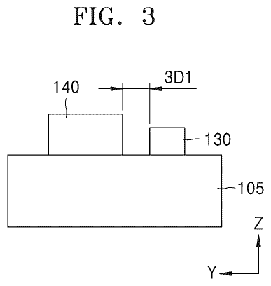

FIG. 2 is a cross-sectional view of FIG. 1 taken along line 2-2′. FIG. 3 is a cross-sectional view of FIG. 1 taken along line 3-3′.

Referring to FIGS. 1 to 3, the first light detector structure 100 may include a first waveguide 110, a second waveguide 130, a first resonator 120, and a second resonator 140. In the first light detector structure 100, the number of waveguides or resonators may increase according to the number of wavelength components included in light transmitted to the receiver unit from a transmitter unit (transmitter) of the optical interconnect device, i.e., channels. The received light may be an optical signal or optical data transmitted from the transmitter unit (transmitter). The optical signal or optical data may be signals that electric signals input to the transmitter unit (transmitter) through a data input device are converted with an electric-photo conversion manner. The electric-photo converted signals may be multiplexed after modulation and may be transmitted to the received through an optical waveguide. For example, the transmitter unit (transmitter) and the receiver unit (receiver) may be connected to the optical waveguide directly or through a coupler.

The first and second waveguides 110 and 130 may be provided in the receiver unit (receiver) and may be a path of light propagated or transmitted to the receiver unit from the transmitter unit (transmitter). For example, in the transmitter unit (transmitter) and the receiver unit (receiver), the light used for transmission of optical signals may be light included in the infrared band. For example, the light included in the infrared band may be infrared light having a wavelength of about 1,300 nm to about 1,600 nm. However, embodiments are not limited thereto. For example, the wavelength of the infrared light may be about 1,300 nm to about 1,550 nm and may be shorter than 1,300 nm.

The first and second waveguides 110 and 130 may be or include a layer including a material that may minimize loss of light used for transmission of the optical signals. For example, the first and second waveguides 110 and 130 may be a material layer including a material having a relatively low absorption rate with respect to light in the aforementioned wavelength range. For example, the first and second waveguides 110 and 130 may be a layer including Group IV semiconductor materials, for example, a waveguide including silicon (Si). However, embodiments are not limited thereto. For example, a width w1 and a width w2 in a second horizontal direction perpendicular to the length of the first waveguide 110 and the second waveguide 130 (e.g., Y-axis direction) may be equal to each other or different from each other. The widths w1 and w2 of the first and second waveguides 110 and 130 may be less than a radius R1/2 of the second resonator 140. However, embodiments are not limited thereto. For example, the widths w1 and w2 of the first and second waveguides 110 and 130 may each be in a range from about 200 nm to about 800 nm, about 300 nm to about 700 nm, or about 500 nm. However, embodiments are not limited thereto. Light 11L1 transmitted through the first waveguide 110 may include light of multichannel transmitted from the transmitter unit (transmitter) to the receiver unit (receiver). For example, the light 11L1 may include infrared light of various components having different wavelengths from each other.

The first resonator 120 and the second resonator 140 may be micro resonators and a diameter 2R1 of the first resonator 120 and a diameter R1 of the second resonator 140 may be less than or equal to tens of micrometers. The diameter 2R1 of the first resonator 120 and the diameter R1 of the second resonator 140 may be different from each other, and the diameter 2R1 of the first resonator 120 may be greater than the diameter R1 of the second resonator 140. For example, the first resonator 120 may be a ring-type resonator, and the diameter 2R1 may be 20 μm or less, 18 μm or less, 17 μm or less, 16 μm or less, or from about 10 μm to about 20 μm. However, embodiments are not limited thereto. For example, the diameter R1 of the second resonator 140 may be less than or equal to ½ of the diameter 2R1 of the first resonator 120. However, embodiments are not limited thereto. For example, the diameter R1 of the second resonator 140 may be less than or equal to several micrometers, e.g., less than 10 μm, less than or equal to 8 μm, less than or equal to 6 μm, less than or equal to 4 μm, less than or equal to 2 μm, or greater than or equal to 1 μm and less than 10 μm. Light satisfying resonance conditions may be transmitted to the first and second resonators 120 and 140 from the first waveguide 110 or the second waveguide 130. Accordingly, the first and second resonators 120 and 140 may include the same material as the first and second waveguides 110 and 130 or may include different materials from each other from among materials suitable of infrared transmission.

The first and second waveguides 110 and 130 may be arranged to be spaced apart from each other on a substrate 105 and may be parallel with each other in a first horizontal direction (e.g. X-axis direction). The first resonator 120 may be provided between the first waveguide 110 and the second waveguide 130 and may have a circular plane shape. The first resonator 120 may be arranged to be spaced apart from the first and second waveguides 110 and 130 but adjacent to the first and second waveguides 110 and 130 such that light is transmitted from the first waveguide 110 to the first resonator 120 and from the first resonator 120 to the second waveguide 130. For example, as illustrated in FIG. 2, the first resonator 120 and the first waveguide 110 may be spaced apart from each other by a first distance 2D1, and the first resonator 120 and the second waveguide 130 may be spaced apart from each other by a second distance 2D2. For example, the first and second distances 2D1 and 2D2 may be equal to each other of different from each other. For example, the first and second distances 2D1 and 2D2 may be about 50 nm to about 200 nm. However, an upper limit and a lower limit of the first and second distances 2D1 and 2D2 are not limited thereto. The first resonator 120 may be arranged on a first side of the second waveguide 130, and the second resonator 140 may be arranged on a second side of the second waveguide 130 opposite to the first side of the second waveguide 130. For example, the second waveguide 130 may be provided between the first and second resonators 120 and 140. The light transmitted from the first waveguide 110 to the first resonator 120 may proceed along the first resonator 120 and may be transmitted from the first resonator 120 to the second waveguide 130 at a location adjacent to the second waveguide 130. In this manner, from the light 11L1 transmitted through the first waveguide 110, light (wavelengths) 12L1 of a specific wavelength range satisfying particular resonance conditions of the first resonator 120 may be transmitted to the first resonator 120, and the light 12L1 may be transmitted from the first resonator 120 to the second waveguide 130. Light 13L1 transmitted from the first resonator 120 to the second waveguide 130 may be transmitted to the second resonator 140. The second resonator 140 may be arranged adjacent to the second waveguide 130. For example, the second resonator 140 and the second waveguide 130 may be spaced apart from each other by a third distance 3D1 in the second horizontal direction (Y-axis direction) as illustrated in FIG. 3. The third distance 3D1 may be equal to or different from the first and second distances 2D1 and 2D2. For example, the third distance 3D1 may be about 50 nm to about 200 nm. However, an upper limit and a lower limit of the distance are not limited thereto. The second resonator 140 may have a circular plane shape and a form of a disk, which will be described later. The second resonator 140 and the first resonator 120 may include the same material (e.g., silicon (Si)), and thus have the same refractive index. As the diameter R1 of the second resonator 140 is less than the diameter of the first resonator 120, in relation to the wavelength, a free spectral range (FSR) of the second resonator 140 may be greater than that of the first resonator 120. Accordingly, the second resonator 140 may detect light of wider bands (e.g., infrared light).

The FSR of micro resonators is inversely proportional to the refractive index of materials included in the resonators. Accordingly, the material and radius (or diameter) of the first resonator 120 and the second resonator 140 may be determined according to an FSR required of the first and second resonators 120 and 140. For example, the FSR of the first resonator 120 having a relatively large diameter greater than a diameter of the second resonator 140 may be about 2 nm to about 16 nm, about 3 nm to about 14 nm, about 5 nm to about 12 nm, or about 6 nm to about 10 nm, However, embodiments are not limited thereto. For example, the FSR of the second resonator 140 having a relatively small diameter smaller than a diameter of the first resonator 120 may be about 16 nm to about 80 nm, about 17 nm to about 78 nm, about 18 nm to about 76 nm, about 20 nm to about 70 nm, or about 25 nm to about 65 nm. However, embodiments are not limited thereto. The diameter 2R1 of the first resonator 120 and the diameter R1 of the second resonator 140 described above may be adjusted according to the aforementioned examples of FSR.

The aforementioned examples of FSR of the first and second resonators 120 and 140 is for when the material of the first and second resonators 120 and 140 is silicon (Si). When the first and second resonators 120 and 140 include a material that has a refractive index different from a refractive index of silicon, the foregoing FSR examples of the first and second resonators 120 and 140 may be changed.

As the diameter of the first resonator 120 is greater than the diameter of the second resonator 140, the FSR of the first resonator 120 may be less than the FSR of the second resonator 140. However, as for the Q value which is related to the wavelength selectivity, the first resonator 120 have a greater Q value than a Q value of the second resonator 140. Accordingly, a wavelength selectivity of the first resonator 120 may be greater than a wavelength selectivity of the second resonator 140. For example, the selection of wavelength may be performed more accurately through the first resonator 120.

As such, by using both of the first resonator 120 and the second resonator 140 which are in a complementary relation with each other, optical signals (wavelengths) transmitted from the transmitter unit (transmitter) of the optical interconnect device may be filtered and thus may be more accurately selected in a relatively wide wavelength band, which may lead to more accurate reception and detection of information (data) in wideband.

A substrate 104 on which the first and second waveguides 110 and 130 and the first and second resonators 120 and 140 are arranged may be or include a material layer including a material that has a relatively low absorption rate with respect to infrared light transmitted through the first and second waveguides 110 and 130 and the first and second resonators 120 and 140 and has a lower refractive index than refractive indices of the first and second waveguides 110 and 130 and refractive indices of the first and second resonators 120 and 140. For example, the substrate 104 may be or include a silicon oxide (e.g., SiO2) layer.

As the first and second waveguides 110 and 130 may be a channel or path for transmitted light, the first and second waveguides 110 and 130 may also be referred to as first and second optical transmission line 110 and 130. The waveguides described below may also be referred to as optical transmission lines.

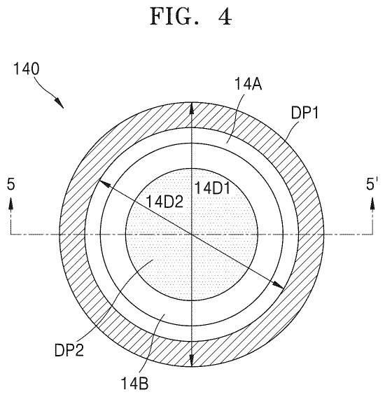

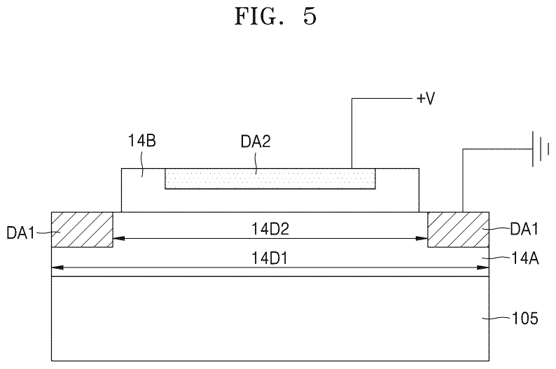

FIG. 4 is a plan view illustrating an example of the disk-type second resonator 140 of FIG. 1, and FIG. 5 is a cross-sectional view of FIG. 4 taken along line 5-5′.

Referring to FIGS. 4 and 5, the second resonator 140 may include a first semiconductor layer 14A and a second semiconductor layer 14B which are sequentially formed on the substrate 105. For example, the first and second semiconductor layers 14A and 14B may be formed by an epitaxial method. However, embodiments are not limited thereto. The first and second semiconductor layers 14A and 14B may have a circular plane shape or a concentric plane shape. The diameter of the first semiconductor layer 14A may be greater than the diameter of the second semiconductor layer 14B. For example, the thicknesses of the first and second semiconductor layers 14A and 14B may be equal to or different from each other in a vertical direction (Z-axis direction). The first semiconductor layer 14A may include a semiconductor material having a relatively low infrared absorption rate, for example, Si. For example, the first semiconductor layer 14A may be or include a silicon layer. The second semiconductor layer 14B may include a material having a relatively high infrared absorption rate, for example, germanium (Ge) having a relatively high light absorption coefficient in a wavelength band used for optical communication (e.g., 1,310 nm to 1,550 nm), Group III-V compound semiconductors, two-dimensional (2D) materials. However, embodiments are not limited thereto. For example, the second semiconductor layer 14B may be or include a Ge layer. For example, the second semiconductor layer 14B may include indium gallium arsenide (InGaAs). For example, the second semiconductor layer 14B may include quantum dots. For example, a dopant injection method may vary according to a material of the second semiconductor layer 14B.

The first semiconductor layer 14A may include a first doping area DA1, and the second semiconductor layer 14B may include a second doping area DA2. The first doping area DA1 may have a plane shape of a ring. An external diameter 14D1 of the first doping area DA1 may be equal to the diameter of the first semiconductor layer 14A as illustrated in FIGS. 4 and 5 or may be less than diameter of the first semiconductor layer 14A. For example, an external edge of the first doping area DA1 may be arranged to be spaced apart from an edge of the first semiconductor layer 14A in the horizontal direction. For example, an internal diameter 14D2 of the first doping area DA1 may be different from the diameter of the second semiconductor layer 14B. For example, the internal diameter 14D2 may be greater than the diameter of the second semiconductor layer 14B. For example, the second semiconductor layer 14B may be arranged inside of the internal diameter 14D2 of the first doping area DA1 and may be arranged apart from the first doping area DA1. However, embodiments are not limited thereto. The diameter of the second doping area DA2 may be less than the diameter of the second semiconductor layer 14B. The second doping area DA2 and the first doping area DA1 may be spaced apart from each other and thus may not be in contact with each other. The second doping area DA2 may be arranged to be spaced apart from a bottom surface of the second semiconductor layer 14B. The second doping area DA2 may be an area arranged at a certain depth from an upper surface of the second semiconductor layer 14B. For example, the thickness of the second doping area DA2 may be equal to or different from the thickness of the second semiconductor layer 14B in the vertical direction (Z-axis direction). For example, the thickness of the second doping area DA2 may be less than the thickness of the second semiconductor layer 14B in the vertical direction (Z-axis direction).

The second doping area DA2 may have a circular plane shape or may be formed to be concentric with respect to the first doping area DA1. The first semiconductor layer 14A and the first doping area DA1 may be concentric, and the second semiconductor layer 14B and the second doping area DA2 may be concentric. Consequentially, the first semiconductor layer 14A, the second semiconductor layer 14B, the first doping area DA1, and the second doping area DA2 may all share the center and be concentric with respect to each other. The thicknesses of the first doping area DA1 and the first semiconductor layer 14A may be equal to or different from each other in the vertical direction (Z-axis direction). For example, the thickness of the first doping area DA1 may be less than the thickness of the first semiconductor layer 14A in the vertical direction (Z-axis direction). The first doping area DA1 may include an area corresponding to the first doping area DA1 of the first semiconductor layer 14A, into which a first dopant, i.e., a first conductive impurity is injected. The first dopant may be distributed evenly over the first doping area DA1. However, embodiments are not limited thereto. The first dopant may be injected by using an ion implantation method. However, embodiments are not limited thereto, and other methods may also be used. For example, the first dopant may include a P-type dopant (e.g., Group III elements) or an N-type dopant (e.g., Group V elements. The second doping area DA2 may include an area corresponding to the second doping area DA2 of the second semiconductor layer 14B and formed by injecting a second dopant, i.e., a second conductive impurity. The second dopant may be distributed evenly over the second doping area DA2. However, embodiments are not limited thereto. The second dopant may be injected by using an ion implantation method. However, embodiments are not limited thereto, and other methods may also be used. For example, the second dopant may include a P-type dopant or an N-type dopant and may be a dopant having a type opposite to that of the first dopant. For example, the first doping area DA1 may be a P-type doping area doped with a P-type dopant, i.e., a P-doping area, and the second doping area DA2 may be an N-type doping area doped with an N-type dopant, i.e., an N-doping area, or the other way around.

Apart from the first doping area DA1, the rest of the first semiconductor layer 14A may be an intrinsic semiconductor area which is substantially not doped with impurities. Apart from the second doping area DA2, the rest of the second semiconductor layer 14B may be an intrinsic semiconductor area which is substantially not doped with impurities.

Consequentially, the disk-type second resonator 140 may also operate as a PIN-type photodiode PD including the P-doping area and the N-doping area which are arranged in the vertical direction (Z-axis direction), and the intrinsic semiconductor provided therebetween.

As the second semiconductor layer 14B is an infrared absorption layer, the light transmitted from the second waveguide 130 to the second resonator 140 may be propagated along the edge of the first semiconductor layer 14A and may be absorbed to the second semiconductor layer 14B, and as illustrated in FIG. 5, when a voltage is applied to the first and second doping areas DA1 and DA2, electrons generated as a result of the infrared absorption by the second semiconductor layer 14B may be detected. For example, when a voltage is applied, electric signals may be generated from the second resonator 140 according to photoelectric conversion. As a result, a particular optical signal (light of particular wavelength) transmitted from the transmitter may be detected through the second resonator 140. Accordingly, when a plurality of resonators such as the second resonator 140 are arranged with different diameters, optical signals may be detected in correspondence to a number of the arranged resonators and optical signals may be detected concurrently.

As described above, as the disk-type second resonator 140 receives light from the second waveguide 130 and also includes a structure for light detection, separate coupling for light detection may not be needed, which leads to a more simplified structure of the optical interconnect device.

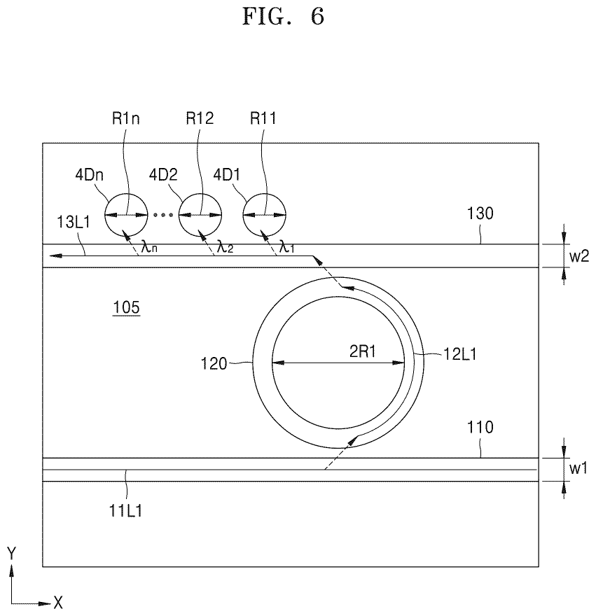

FIG. 6 is a plan view illustrating an example in which a plurality of resonators (4D1, 4D2, . . . , 4Dn) are provided on a side of a second waveguide 130 in the first light detector structure 100 of FIG. 1.

Hereinafter, embodiments are described by focusing on differences from the first light detector structure 100 of FIG. 1. Like reference numerals denote like members, and any redundant description will be omitted.

Referring to FIG. 6, instead of the second resonator 140 of the first light detector structure 100, the plurality of disk-type resonators 4D1, 4D2, . . . , 4Dn may be arranged (aligned) side by side along the second waveguide 130. For example, the second waveguide 130 may be arranged between the first resonator 120 and the plurality of resonators 4D1, 4D2, . . . , 4Dn. The plurality of resonators 4D1, 4D2, . . . , 4Dn may also be referred to as a resonator array. The plurality of resonators 4D1, 4D2, . . . , 4Dn may be arranged to be spaced apart from each other to the extent that optical interference among them may be blocked. For example, a distance between the resonators 4D1, 4D2, . . . , 4Dn may be greater than a distance between the second waveguide 130 and the resonators 4D1, 4D2, . . . , 4Dn. The plane shape, layer structure, and layer configuration of each of the resonators 4D1, 4D2, . . . , 4Dn may be equal to those of the second resonator 140. The plurality of resonators 4D1, 4D2, . . . , 4Dn may have different diameters R11, R12, . . . , R1n from each other. As light having a wavelength corresponding to resonance conditions of each of the resonators 4D1, 4D2, . . . , 4Dn may be transmitted to each of the resonators 4D1, 4D2, . . . , 4Dn, wavelengths λ1, λ2, . . . , λn of light transmitted from the second waveguide 130 to the plurality of resonators 4D1, 4D2, . . . , 4Dn may be different from each other. For example, infrared light having the first wavelength λ1 corresponding to resonance conditions of the first resonator 4D1 may be transmitted from the second waveguide 130 to the first resonator 4D1 of the plurality of resonators 4D1, 4D2, . . . , 4Dn forming an array in line, and infrared light having the second wavelength λ2 corresponding to resonance conditions of the second resonator 4D2 may be transmitted from the second waveguide 130 to the second resonator 4D2. The first wavelength λ1 and the second wavelength λ2 may be different from each other. As the light transmitted to the plurality of resonators 4D1, 4D2, . . . , 4Dn corresponds to the optical signals of multi-channel transmitted from the transmitter unit, by providing the plurality of resonators 4D1, 4D2, . . . , 4Dn in correspondence to the number of the multi-channel, the optical signals of the multi-channel may be detected concurrently.

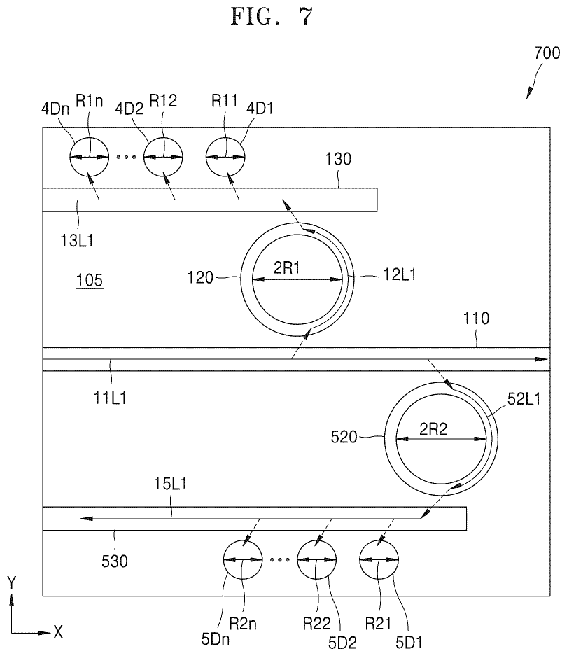

FIG. 7 is a plan view of a second light detector structure 700 of an optical interconnect device according to one or more other embodiments.

The second light detector structure 700 may be a variation of the light detector structure described in relation to FIG. 6. Accordingly, embodiments are described by focusing on differences from the light detector structure of FIG. 6. Like reference numerals denote like members, and any redundant description will be omitted.

Referring to FIG. 7, the second light detector structure 700 may be a resonator arranged adjacent to the first waveguide 110 and may include the first resonator 120 and a ring-type third resonator 520. The first resonator 120 and the third resonator 520 may be provided on either side of the first waveguide 110. For example, the first waveguide 110 may be arranged between the first resonator 120 and the third resonator 520. For example, the first resonator 120 may be provided on the first side of the first waveguide 110 and the third resonator 520 may be provided on the second side of the first waveguide 110 opposite to the first side of the first waveguide 110. As another example, the third resonator 520 may be provided on the first side of the first waveguide 110 and the first resonator 120 may be provided on the second side of the first waveguide 110 opposite to the first side of the first waveguide 110. The first resonator 120 and the third resonator 520 may be arranged to be spaced apart from each other in the first horizontal direction (X-axis direction). Accordingly, the first resonator 120 and the third resonator 520 may not overlap each other in the second horizontal direction (Y-axis direction). The second light detector structure 700 may include a third waveguide 530. The third waveguide 530 may be arranged partially or entirely in parallel with the first waveguide 110. The first waveguide 110 may be arranged between the second waveguide 130 and the third waveguide 530. The first to third waveguides 110, 130, and 530 may be arranged in parallel with each other. However, embodiments are not limited thereto. The materials and widths of the third waveguide 530 and the second waveguide 130 may be equal to or different from each other. The third resonator 520 may be arranged between the first waveguide 110 and the third waveguide 530. The third resonator 520 may be arranged adjacent to the first and third waveguides 110 and 530. A range of a distance between the third resonator 520 and the first and third waveguides 110 and 530 may be equal to a range of a distance between the first resonator 120 and the first and second waveguides 110 and 130. Accordingly, light may be transmitted from the first waveguide 110 to the third resonator 520 and from the third resonator 520 to the third waveguide 530.

The diameter 2R2 of the third resonator 520 may be different from the diameter 2R1 of the first resonator 120. For example, the diameter 2R2 of the third resonator 520 may be greater than or less than the diameter 2R1 of the first resonator 120. Materials of the third resonator 520 and the first resonator 120 may be equal to or different from each other. For example, a material of the third resonator 520 may be different from a material of the first resonator 120 from among substances that may be used as a material of the first waveguide 110 or the first resonator 120 (e.g., Si, SiN, etc.) For example, the material of the third resonator 520 may be equal to that of the first resonator 120, and the diameter 2R2 of the third resonator 520 may be different from the diameter 2R1 of the first resonator 120. Accordingly, components (for example, wavelengths) of light transmitted from the first waveguide 110 to the third resonator 520 may be different from components (for example, wavelengths) of light transmitted from the first waveguide 110 to the first resonator 120. For example, among the components of the light 11L1 transmitted through the first waveguide 110, wavelengths 12L1 (optical signals) satisfying the resonance conditions of the first resonator 120 may be transmitted to the first resonator 120, and wavelengths 52L1 (optical signals) satisfying the resonance conditions of the third resonator 520 may be transmitted to the third resonator 520. The wavelengths 12L1 transmitted to the first resonator 120 may be propagated through the second waveguide 130 and may be detected at the plurality of resonators 4D1, 4D2, . . . , 4Dn. The wavelengths 52L1 transmitted to the third resonator 520 may be propagated through the third waveguide 530 and may be detected at a plurality of resonators 5D1, 5D2, . . . , 5Dn (n=1, 2, 3, . . . ). The plurality of resonators 5D1, 5D2, . . . , 5Dn may be provided on a side of the third waveguide 530 opposite to another side of the third waveguide 530 on which the third resonator 520 is arranged. For example, the third waveguide 530 may be arranged between the third resonator 520 and the plurality of resonators 5D1, 5D2, . . . , 5Dn. Each of the plurality of resonators 5D1, 5D2, . . . , 5Dn may be a disk-type resonator. The material, layer configuration, and layer structure of each of the resonators 5D1, 5D2, . . . , 5Dn may be equal to those of the second resonator 140. However, detailed specification (e.g., thickness, interlayer width, etc.) thereof may be different from that of the second resonator 140. Diameters R21, R22, . . . , R2n of the resonators 5D1, 5D2, . . . , 5Dn may be different from each other and may be different from the diameters of the plurality of resonators 4D1, 4D2, . . . , 4Dn arranged adjacent to the second waveguide 130. The diameters R21, R22, . . . , R2n of the plurality of resonators 5D1, 5D2, . . . , 5Dn may be less than the diameter 2 R2 of the third resonator 520. For example, each of the diameters R21, R22, . . . , R2n of the plurality of resonators 5D1, 5D2, . . . , 5Dn may be less than or equal to ½, ⅓, or ¼ of the diameter 2R2 of the third resonator 520. However, embodiments are not limited thereto. For example, a range of the diameter 2R2 of the third resonator 520 may be within a range of the diameter 2R1 of the first resonator 120. However, embodiments are not limited thereto.

As the diameters R21, R22, . . . , R2n of the plurality of resonators 5D1, 5D2, . . . , 5Dn are different from each other, components (for example, wavelengths) included in light 15L1 transmitted from the third resonator 520 to the third waveguide 530 may be transmitted to and detected at each of the resonators 5D1, 5D2, . . . , 5Dn.

The plurality of resonators 5D1, 5D2, . . . , 5Dn may be arranged in line along the third waveguide 530 and may be arranged to be spaced apart from the third waveguide 530 by the same distance. However, embodiments are not limited thereto. The plurality of resonators 5D1, 5D2, . . . , 5Dn may also be referred to as a resonator array.

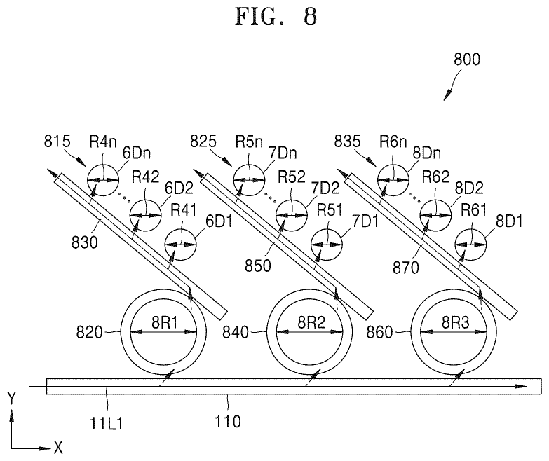

FIG. 8 is a plan view of a third light detector structure 800 of an optical interconnect device according to one or more embodiments.

Referring to FIG. 8, the third light detector structure 800 may include the first waveguide 110 and a ring-type fourth resonator 820, a ring-type fifth resonator 840, and a ring-type sixth resonator 860 arranged adjacent to the first waveguide 110, and a fourth waveguide 830, a fifth waveguide 850, and a sixth waveguide 870 may be arranged in correspondence to the fourth to sixth resonators 820, 840, and 860. A first resonator array 815, a second resonator array 825, and a third resonator array 835 may be arranged in correspondence to the fourth to sixth waveguides 830, 850, and 870. All of the fourth to sixth resonators 820, 840, and 860 may be provided on a first side of the first waveguide 110. The fourth to sixth resonators 820, 840, and 860 may be arranged in line along the first waveguide 110. Accordingly, the fourth to sixth resonators 820, 840, and 860 may be referred to as a resonator array or a ring-type resonator array, and such resonator array may further include, in addition to the fourth to sixth resonators 820, 840, and 860, at least one large-diameter resonator having a diameter different from diameters of the fourth to sixth resonators 820, 840, and 860.

The fourth to sixth resonators 820, 840, and 860 may be arranged to be spaced apart from each other in the first horizontal direction (X-axis direction) of the first waveguide 110. A distance between the fourth to sixth resonators 820, 840, and 860 may be greater than a distance between the first waveguide 110 and the fourth to sixth resonators 820, 840, and 860. Accordingly, optical interference among the fourth to sixth resonators 820, 840, and 860 may be prevented. The distance between the first waveguide 110 and the fourth to sixth resonators 820, 840, and 860 may be within the range of distance between the first waveguide 110 and the first resonator 120 described above in relation to FIG. 1. Accordingly, light may be transmitted from the first waveguide 110 to the fourth to sixth resonators 820, 840, and 860. Diameters 8R1, 8R2, and 8R3 of the fourth to sixth resonators 820, 840, and 860 may be different from each other. Thus, components (for example, wavelengths) of light transmitted from the first waveguide 110 to the fourth to sixth resonators 820, 840, and 860 may be different from each other. The diameters 8R1, 8R2, and 8R3 of the fourth to sixth resonators 820, 840, and 860 may be within the range of diameter of the first resonator 120. A material of the fourth to sixth resonators 820, 840, and 860 may be equal to a material of the first resonator 120 or may be selected from among materials that may be used as a material of the first resonator 120 but is different from the material of the first resonator 120.

The fourth to sixth waveguides 830, 850, and 870 may not be parallel with the first waveguide 110. For example, the fourth to sixth waveguides 830, 850, and 870 may be inclined with respect to the first waveguide 110 and may be arranged to form an acute angle with respect to the first waveguide 110 in a clockwise direction. The fourth to sixth waveguides 830, 850, and 870 may be arranged in parallel with each other. However, embodiments are not limited thereto. For example, inclination angles of the fourth to sixth waveguides 830, 850, and 870 with respect to the first waveguide 110 may be different from each other.

A part of the fourth waveguide 830 may be arranged adjacent to the fourth resonator 820. A distance between the fourth waveguide 830 and the fourth resonator 820 may be within the distance range between the fourth resonator 820 and the first waveguide 110. A part of the fifth waveguide 850 may be arranged adjacent to the fifth resonator 840. A distance between the fifth waveguide 850 and the fifth resonator 840 may be within the distance range between the fifth resonator 840 and the first waveguide 110. A part of the sixth waveguide 870 may be arranged adjacent to the sixth resonator 860. A distance between the sixth waveguide 870 and the sixth resonator 860 may be within the distance range between the sixth resonator 860 and the first waveguide 110. Accordingly, light may be transmitted from the fourth to sixth resonators 820, 840, and 860 to the fourth to sixth waveguides 830, 850, and 870. Each of the resonators 6D1, 6D2, . . . , 6Dn (n=1, 2, 3, . . . ) of the first resonator array 815 which are arranged adjacent to the fourth waveguide 830 may be a disk-type resonator, and the material, layer structure, and layer configuration thereof may be equal to or different from those of the second resonator 140. The resonators 6D1, 6D2, . . . , 6Dn may have different diameters R41, R42, . . . , R4n from each other. The diameters R41, R42, . . . , R4n of the resonators 6D1, 6D2, . . . , 6Dn may be less than or equal to ½, ⅓, or ¼ of the diameter 8R1 of the fourth resonator 820. However, embodiments are not limited thereto.

Each of the resonators 7D1, 7D2, . . . , 7Dn of the second resonator array 825 which are arranged adjacent to the fifth waveguide 850 may be a disk-type resonator, and the material, layer structure, and layer configuration thereof may be equal to or different from those of the second resonator 140. The resonators 7D1, 7D2, . . . , 7Dn may have different diameters R51, R52, . . . , R5n from each other. The diameters R51, R52, . . . , R5n of the resonators 7D1, 7D2, . . . , 7Dn may be less than or equal to ½, ⅓, or ¼ of the diameter 8R2 of the fifth resonator 840. However, embodiments are not limited thereto.

Each of the resonators 8D1, 8D2, . . . , 8Dn of the third resonator array 835 which are arranged adjacent to the sixth waveguide 870 may be a disk-type resonator, and the material, layer structure, and layer configuration thereof may be equal to or different from those of the second resonator 140. The resonators 8D1, 8D2, . . . , 8Dn may have different diameters R61, R62, . . . , R6n from each other. The diameters R61, R62, . . . , R6n of the resonators 8D1, 8D2, . . . , 8Dn may be less than or equal to ½, ⅓, or ¼ of the diameter 8R3 of the sixth resonator 860. However, embodiments are not limited thereto.

Although FIG. 8 illustrates that only three resonators (820, 840, and 860) having a relatively large diameter are arranged adjacent to the first waveguide 110 to select optical components (for example, wavelengths) included in the light 11L1 transmitted through the first waveguide 110, three or more resonators having a large diameter may be arranged adjacent to the first waveguide 110. Accordingly, three or more waveguides inclined with respect to the first waveguide 110 may be provided, and three or more resonator arrays including a plurality of relatively small-diameter disk-type resonators in correspondence to the inclined waveguides may be provided. The number of disk-type resonators included in all resonator arrays (815, 825, and 835) may be smaller than or equal to the number of the multi-channel.

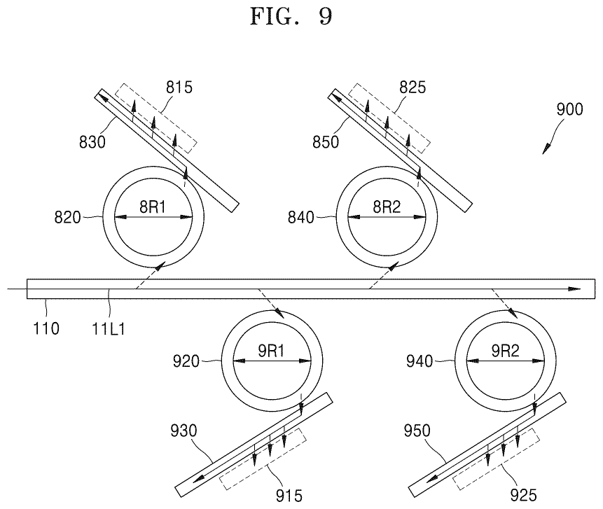

FIG. 9 is a plan view of a fourth light detector structure 900 of an optical interconnect device according to one or more embodiments. Hereinafter, embodiments are described focusing on differences between the fourth light detector structure 900 and the third light detector structure 800 of FIG. 8. Like reference numerals denote like members, and any redundant description is omitted.

Referring to FIG. 9, in the fourth light detector structure 900, the fourth and fifth resonators 820 and 840 may be arranged on one side of the first waveguide 110 and a seventh resonator 920 and an eighth resonator 940 may be arranged on the other side of the first waveguide 110. The seventh and eighth resonators 920 and 940 may be arranged to be spaced apart from each other horizontally.

The fourth and fifth resonators 820 and 840 may be referred to as the first resonator array or the first ring-type resonator array, and the seventh and eighth resonators 920 and 940 may be referred to as the second resonator array or the second ring-type resonator array. For example, the first resonator array may further include at least one relatively large-diameter resonator in addition to the fourth and fifth resonators 820 and 840, and the second resonator array may further include at least one relatively large-diameter array in addition to the seventh and eighth resonators 920 and 940.

The seventh and eighth resonators 920 and 940 may be arranged not to overlap the fourth and fifth resonators 820 and 840 in the second horizontal direction (Y-axis direction), However, embodiments are not limited thereto. The diameters 9R1 and 9R2 of the seventh and eighth resonators 920 and 940 may be different from each other and from the diameters 8R1 and 8R2 of the fourth and fifth resonators 820 and 840. The distance between the seventh and eighth resonators 920 and 940 may be greater than the distance between the first waveguide 110 and the seventh and eighth resonators 920 and 940. Accordingly, optical interference between the seventh and eighth resonators 920 and 940 may be prevented. The distance between the first waveguide 110 and the seventh and eighth resonators 920 and 940 may be within the distance between the first waveguide 110 and the fourth and fifth resonators 820 and 840. The material of the seventh and eighth resonators 920 and 940 may be the same as the material of the fourth and fifth resonators 820 and 840. The fourth light detector structure 900 may include the seventh waveguide 930 provided in correspondence to the seventh resonator 920, the eighth waveguide 950 provided in correspondence to the eighth resonator 940, the fourth resonator array 915 provided in correspondence to the seventh waveguide 930, and the fifth resonator array 925 provided in correspondence to the eighth waveguide 950. The seventh and eighth waveguides 930 and 950 may be inclined with respect to the first waveguide 110. The seventh and eighth waveguides 930 and 950 may be arranged to form an acute angle with respect to the first waveguide 110 in a counterclockwise direction. The material of the seventh and eighth waveguides 930 and 950 may be equal to the material of the fourth and fifth waveguides 830 and 850. A part of the seventh waveguide 930 may be arranged adjacent to the seventh resonator 920. The distance between the seventh waveguide 930 and the seventh resonator 920 may be within the distance range between the first waveguide 110 and the seventh resonator 920. The distance between the eighth waveguide 950 and the eighth resonator 940 may be within the distance range between the first waveguide 110 and the eighth resonator 940. The fourth light detector structure 900 may include the fourth resonator array 915 provided in correspondence to the seventh waveguide 930 and the fifth resonator array 925 provided in correspondence to the eighth waveguide 950. The fourth resonator array 915 may include a plurality of disk-type resonators such as the resonators 6D1, 6D2, . . . , 6Dn included in the first resonator array 815 as illustrated in FIG. 8, and the diameters of the plurality of disk-type resonators may be different from each other. Similar to the fourth resonator array 915, the fifth resonator array 925 may also include a plurality of disk-type resonators, and the diameters of the plurality of disk-type resonators may be different from each other. The materials of all of the resonators included in the fourth and fifth resonator arrays 915 and 925 may be the same, but the diameters thereof may be different from each other. The distance between the seventh waveguide 930 and the plurality of resonators included in the fourth resonator array 915 may be within the distance range between the seventh waveguide 930 and the seventh resonator 920. The distance between the eighth waveguide 950 and the plurality of resonators included in the fifth resonator array 925 may be within the distance range between the eighth waveguide 950 and the eighth resonator 940. The diameters of the resonators included in the fourth resonator array 915 may be less than or equal to ½, ⅓, or ¼ of the diameter 9R1 of the resonator 920 corresponding thereto. However, embodiments are not limited thereto.

The diameters of the resonators included in the fifth resonator array 925 may be less than or equal to ½, ⅓, or ¼ of the diameter 9R2 of the resonator 940 corresponding thereto. However, embodiments are not limited thereto.

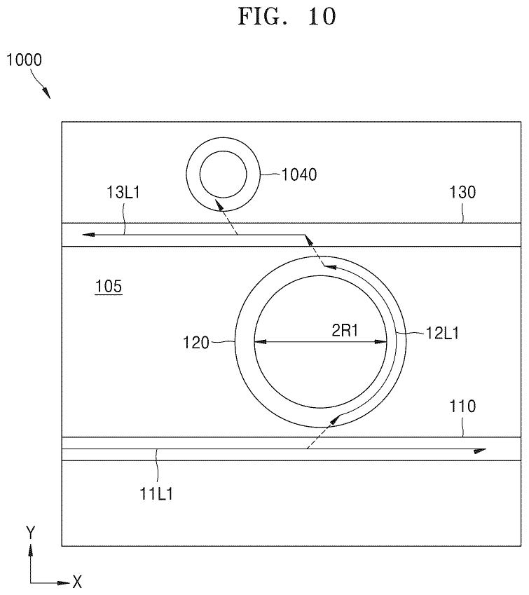

FIG. 10 is a plan view of a fifth light detector structure 1000 of an optical interconnect device according to one or more embodiments.

The fifth light detector structure 1000 may be the same as the first light detector structure 100 of FIG. 1 except that the second resonator 140 is substituted with a ring-type resonator 1040. Two or more ring-type resonators 1040 may be arranged with respect to the second waveguide 130.

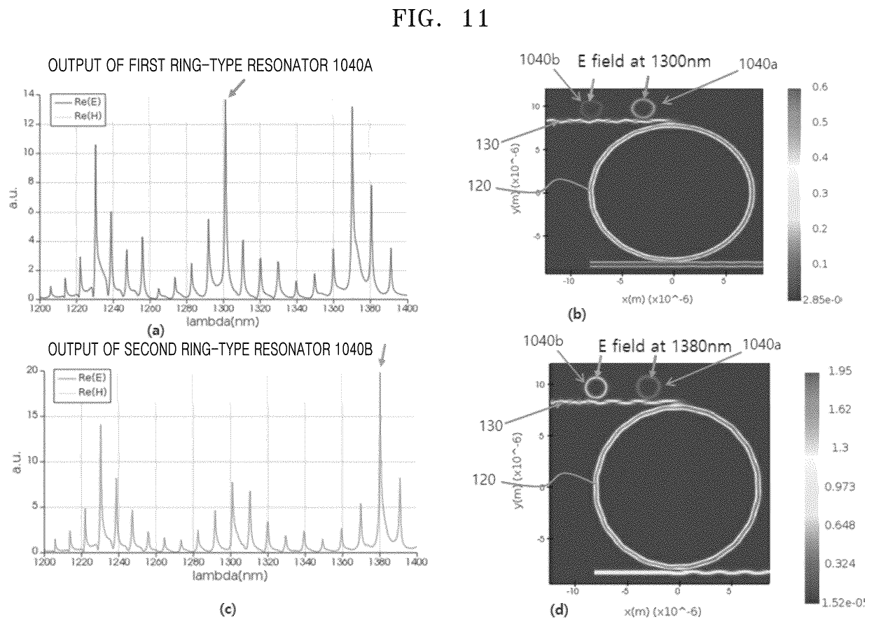

FIG. 11 shows a first simulation result for a light detector structure of an optical interconnect device according to one or more embodiments.

The first simulation is about the case where, in the fifth light detector structure 1000 of FIG. 10, two ring-type resonators 1040 are provided in correspondence to the second waveguide 130. In FIG. 11, the reference numerals 1040a and 1040b respectively denote two ring-type resonators provided in correspondence to the second waveguide 130, i.e., the first and second ring-type resonators. The materials of the first and second ring-type resonators 1040a and 1040b are equal to each other, and the diameters thereof are different from each other.

In the first simulation, the diameter of the first resonator 120 arranged adjacent to the first waveguide 110 is set to be 8 μm, the first waveguide 110 and the second waveguide 130 are silicon waveguides, and the first and second ring-type resonators 1040a and 1040b arranged adjacent to the second waveguide 130 have first and second diameters, respectively. The first diameter is a diameter causing resonance to light having a wavelength of 1,300 nm, and the second diameter is a diameter causing resonance to light having a wavelength of 1,380 nm.

(a) and (b) of FIG. 11 show electric field distribution of the first ring-type resonator 1040a having the first diameter when infrared light is transmitted through the first waveguide 110, and (c) and (d) show electric field distribution of the second ring-type resonator 1040b having the second diameter.

(a) and (c) of FIG. 11 show a wavelength-electric field intensity relation at the first and second ring-type resonators 1040a and 1040b, and (b) shows electric field intensities at the first resonator 120, the first and second ring-type resonators 1040a and 1040 b, and the waveguide 130 when light having a wavelength of 1,300 nm is transmitted. (d) shows electric field intensities at the first resonator 120, the first and second ring-type resonators 1040a and 1040b, and the waveguide 130 when light having a wavelength of 1,380 nm is transmitted.

Referring to (a) and (b) of FIG. 11, when the wavelength of light transmitted to the light detector structure is 1,300 nm, the electric field intensity of the first resonator 120 is relatively high, and between the first and second ring-type resonators 1040a and 1040b, the electric field intensity of the first ring-type resonator 1040a having the first diameter is greater than the electric field intensity of the second ring-type resonator 1040b having the second diameter. Such a result indicates that light having a wavelength of 1,300 nm from among the optical components transmitted to the light detector structure is selected by the first ring-type resonator 1040a having the first diameter.

Referring to (c) and (d) of FIG. 11, when the wavelength of light transmitted to the light detector structure is 1,380 nm, the electric field intensity of the first resonator 120 is relatively high, and between the first and second ring-type resonators 1040a and 1040b, the electric field intensity of the second ring-type resonator 1040b having the second diameter is greater than the electric field intensity of the first ring-type resonator 1040a having the first diameter. Such a result indicates that light having a wavelength of 1,380 nm from among the optical components transmitted to the light detector structure is selected by the second ring-type resonator 1040b having the second diameter.

The foregoing results suggest that when the ring-type resonator having different diameters from each other are arranged at the second waveguide 130, light of a particular wavelength may be selected according to the diameters of the ring-type resonators, and other light may be filtered.

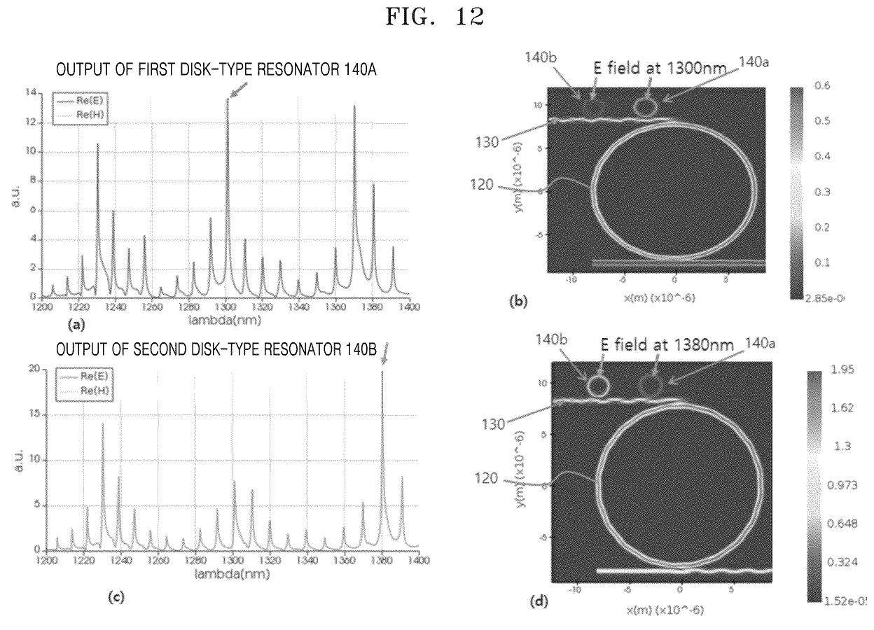

FIG. 12 shows a second simulation result for a light detector structure of an optical interconnect device according to one or more embodiments.

In the second simulation, the first ring-type resonator 1040a and the second ring-type resonator 1040b arranged adjacent to the second waveguide 130 in the first simulation are substituted with a disk-type first resonator 140a and a second resonator 140b.

The setting of the diameters of the first and second disk-type resonators 140a and 140b is the same as that of the diameters of the first and second ring-type resonators 1040a and 1040b.

(a) and (b) of FIG. 12 show electric field distribution of the first disk-type resonator 140a having a first diameter when infrared light is transmitted through the first waveguide 110, and (c) and (d) show electric field distribution of the second disk-type resonator 140b having a second diameter which is different from the first diameter.

(a) and (c) of FIG. 12 show a wavelength-electric field intensity relation at the first and second resonators 140a and 140b, and (b) shows electric field intensities at the first resonator 120, the first and second resonators 140a and 140b, and the waveguide 130 when light having a wavelength of 1,300 nm is transmitted. (d) shows electric field intensities at the first resonator 120, the first and second resonators 140a and 140 b, and the waveguide 130 when light having a wavelength of 1,380 nm is transmitted.

Referring to (a) and (b) of FIG. 12, when the wavelength of light transmitted to the light detector structure is 1,300 nm, the electric field intensity of the first resonator 120 is relatively high, and between the first and second resonators 140a and 140b, the electric field intensity of the first resonator 140a having the first diameter is greater than the electric field intensity of the second resonator 140b having the second diameter. Such a result indicates that light having a wavelength of 1,300 nm from among the optical components transmitted to the light detector structure is selected by the first disk-type resonator 140a having the first diameter.

Referring to (c) and (d) of FIG. 12, when the wavelength of light transmitted to the light detector structure is 1,380 nm, the electric field intensity of the first resonator 120 is relatively high, and between the first and second resonators 140a and 140b, the electric field intensity of the second disk-type resonator 140b having the second diameter is greater than the electric field intensity of the first disk-type resonator 140a having the first diameter. Such a result indicates that light having a wavelength of 1,380 nm from among the optical components transmitted to the light detector structure is selected by the second disk-type resonator 140b having the second diameter.

The foregoing results suggest that when the disk-type resonator having different diameters from each other are arranged at the second waveguide 130, light of a particular wavelength may be selected according to the diameters of the resonators, and other light may be filtered.

Hereinafter, a manufacturing method of a light detector structure of an optical interconnect device according to one or more embodiments is described.

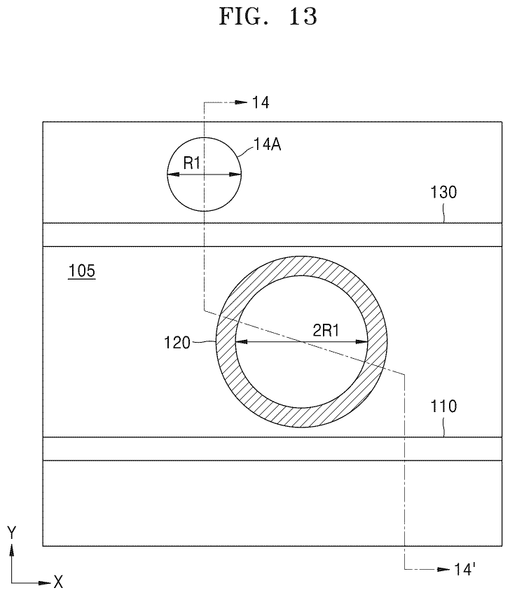

FIGS. 13 to 21 are plan views and cross-sectional views illustrating a manufacturing method of a light detector structure of an optical interconnect device according to one or more embodiments. In this regard, like reference numerals denote like members, and any redundant description is omitted.

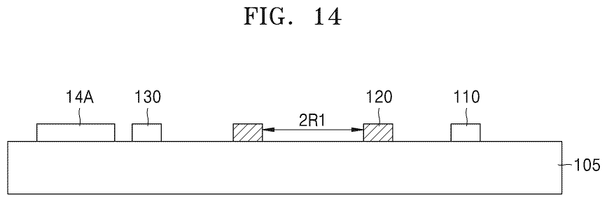

FIGS. 13 and 14 illustrate formation of the waveguides and a part of resonators on the substrate 105. FIG. 14 is a cross-sectional view of FIG. 13 taken along line 14-14′.

Referring to FIGS. 13 and 14, the first and second waveguides 110 and 130 and the first resonator 120 may be formed on the substrate 105, and then the first semiconductor layer 14A may be formed. The first semiconductor layer 14A may be formed at a position corresponding to the second resonator 140 of FIG. 1. The first and second waveguides 110 and 130 and the first resonator 120 may be formed to be in the arrangement relation described in relation to FIG. 1.

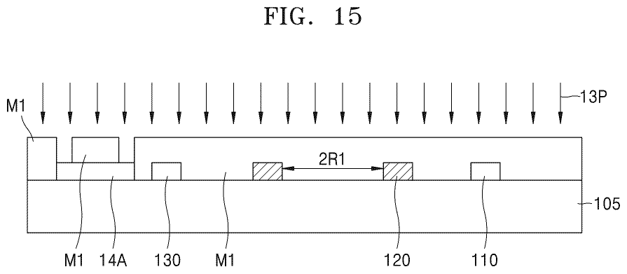

Then, as illustrated in FIG. 15, a first mask M1 exposing a partial area of the first semiconductor layer 14A may be formed on the substrate 105. In the formation of the first mask M1, except for the exposed partial area of the first semiconductor layer 14A, the first and second waveguides 110 and 130 and the first resonator 120 formed on the substrate 105 may be covered by the first mask M1, and an upper surface of the substrate 105 may be covered by the first mask M1. The first mask M1 may be a photosensitive film. However, embodiments are not limited thereto. The exposed partial area of the first semiconductor layer 14A may be an area corresponding to the first doping area DP1 described in relation to FIGS. 4 and 5. For example, the first mask M1 may be formed to partially cover the edge of the upper surface of the first semiconductor layer 14A.

After the first mask M1 is formed, the first dopant 13P may be ion-implanted into the exposed area of the first semiconductor layer 14A. The first dopant 13P may include the first dopant described in relation to FIGS. 4 and 5. The first dopant 13P may be injected by various methods other than the ion implantation.

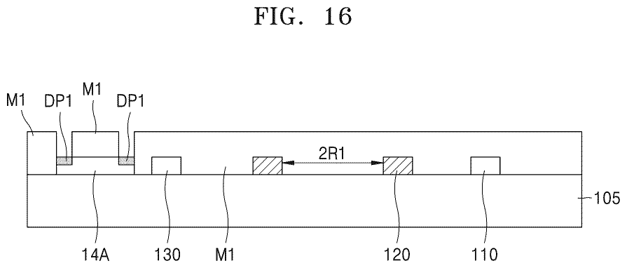

The first dopant 13P may be injected with injection energy sufficient for the dopants to reach a certain depth (set depth) from the upper surface of the first semiconductor layer 14A in the vertical direction (Z-axis direction). According to the injection of the first dopant 13P, as illustrated in FIG. 16, the first doping area DP1 having a thickness thinner than the thickness of the first semiconductor layer 14A may be formed at the first semiconductor layer 14A. For example, the first dopant 13P may be injected with injection energy sufficient for the dopants to reach the bottom of the first semiconductor layer 14A.

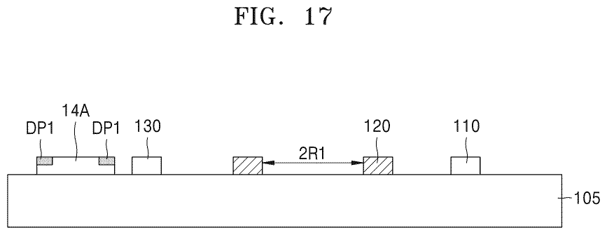

Then, the first mask M1 may be removed. FIG. 17 illustrates a result of removal of the first mask M1.

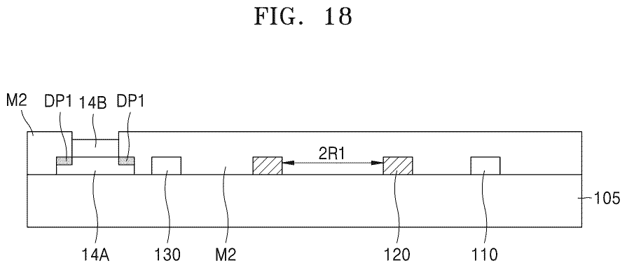

As illustrated in FIG. 18, a second mask M2 may be formed on the substrate 105 to expose a part of the first semiconductor layer 14A inside the first doping area DP1. The second mask M2 may be a photosensitive film. However, embodiments are not limited thereto. The second mask M2 may be formed to cover first and second waveguides 110 and 130 and the first resonator 120 on the substrate 105 except for the exposed area of the first semiconductor layer 14A and cover the first doping area DA1 and the upper surface of the substrate 105.

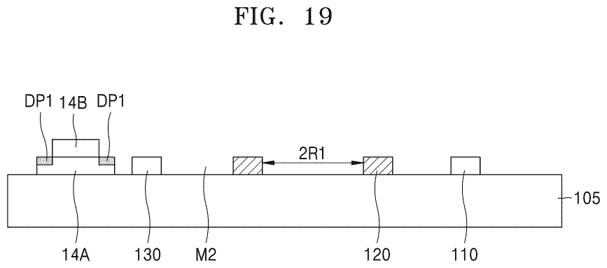

As the exposed area of the first semiconductor layer 14A corresponds to the area in which the second semiconductor layer 14B of FIG. 5 is to be formed, by considering this, the exposed area of the first semiconductor layer 14A may be defined in the formation of the second mask M2. While the second mask M2 is still present, the second semiconductor layer 14B may be grown on the exposed area of the first semiconductor layer 14A. After growing the second semiconductor layer 14B, the second mask M2 may be removed. FIG. 19 illustrates a result of removal of the second mask M2.

Referring to FIG. 19, the second semiconductor layer 14B may be formed on the first semiconductor layer 14A inside the first doping area DP1. The entire second semiconductor layer 14B may be present on the first semiconductor layer 14A, and the edge of the second semiconductor layer 14B may be arranged to be spaced apart from the first doping area DP1. For example, the second semiconductor layer 14B may entirely overlap with the first semiconductor layer 14A in the vertical direction (Z-axis direction), and in the horizontal direction, the lateral surface of the second semiconductor layer 14B may be arranged to be spaced apart from the first doping area DP1.

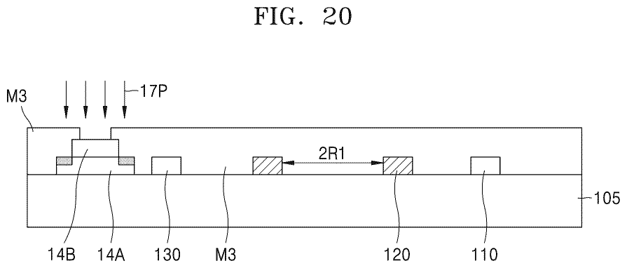

As illustrated in FIG. 20, a third mask M3 may be formed on the substrate 105 on which the second semiconductor layer 14B is formed to expose a part of the second semiconductor layer 14B. The third mask M3 may be a photosensitive film. However, embodiments are not limited thereto.

The third mask M3 may be formed to be provided on and cover the first and second waveguides 110 and 130, the first resonator 120, the first semiconductor layer 14A, and the first doping area DP1 on the circumference of the second semiconductor layer 14B on the substrate 105 and the upper surface of the substrate 105. The area of the second semiconductor layer 14B, which is exposed by the third mask M3 may be an area corresponding to the second doping area DP2 of FIGS. 4 and 5. Accordingly, in the formation of the third mask M3, the exposed area of the second semiconductor layer 14B may be defined by considering the above. After the third mask M3 is formed, the second dopant 17P may be injected into the exposed area of the second semiconductor layer 14B. The second dopant 17P may include the second dopant described in relation to FIGS. 4 and 5. The second dopant 17P may be injected by using the ion implantation. However, embodiments are not limited thereto. In the injection of the second dopant 17P, the second dopant 17P may be injected with ion implantation energy sufficient for the second dopant 17P to reach a certain depth (set depth) from the upper surface of the second semiconductor layer 14B or with ion implantation energy sufficient for the second dopant 17P to reach the bottom surface of the second semiconductor layer 14B. The certain depth may be less than the thickness of the second semiconductor layer 14B.

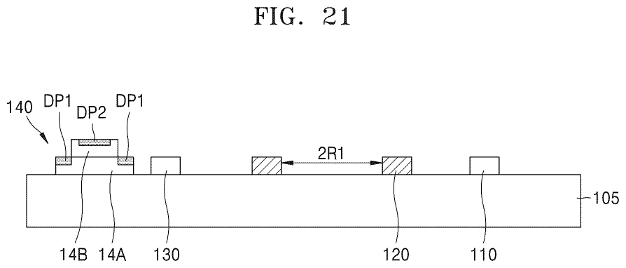

The second doping area DP2 may be formed at the second semiconductor layer 14B by the injection of the second dopant 17P as illustrated in FIG. 21. After the injection of the second dopant 17P is completed, the third mask M3 may be removed.

In this manner, the disk-type second resonator 140 having the light detection structure may be formed in an area adjacent to the second waveguide 130 on the substrate 105. For example, in the process of forming the second resonator 140, two or more second resonators 140 may be formed simultaneously as illustrated in FIG. 6.

In addition, in the formation of the first and second waveguides 110 and 130 and the first resonator 120 illustrated in FIGS. 13 and 14, a plurality of first resonators 120 may be formed, and a plurality of second waveguides 130 may be formed in various forms as illustrated in FIGS. 7 to 9. The plurality of resonators and the plurality of waveguides illustrated in FIGS. 7 to 9 may be formed by, for example, forming a silicon layer on the substrate 105 and then patterning the silicon layer by a photo-etching method.

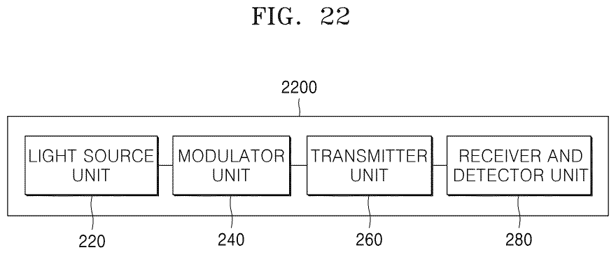

FIG. 22 is a block diagram of an optical interconnect device 2200 according to one or more embodiments.

Referring to FIG. 22, the optical interconnect device 2200 may include a light source unit (light source) 220, a modulator unit (modulator) 240, a transmitter unit (transmitter) 260, and a receiver and detector (receiver and detector) unit 280. The light source unit (light source) 220 may be a light source including, for example, a laser. For example, the light source unit 220 may include a multi-channel laser. The multi-channel laser may include lasers configured to release infrared light having different wavelengths from each other. However, embodiments are not limited thereto. For example, the light source unit (light source) 220 may include a light generator and emit light of multi-channel. The modulator unit (modulator) 240 may include a modulator configured to modulate light emitted from the light source unit (light source) 220. For example, the modulator unit 240 may include a plurality of modulators configured to respectively correspond to channels of the multi-channel layer. Data (electric signals) to be transmitted may be input to the plurality of modulators, and in response to the input data, modulation of light emitted from each channel laser may be performed by each of the modulators. The modulator unit (modulator) 240 may include a driver configured to control driving and operation of each modulator according to input data. The light of each channel which has been modulated at the modulator unit (modulator) 240 may become optical signals corresponding to the data input to the modulator unit (modulator) 240. Such optical signals may be transmitted to the receiver and detector unit (receiver and detector) 280 through the transmitter unit (transmitter) 260. The transmitter unit (transmitter) 260 may multiplex the optical signals of multi-channel modulated and transmitted from the modulator unit (modulator) 240 and transmit the same to the receiver and detector unit (receiver and detector) 280. To this end, the transmitter unit (transmitter) 260 may include a multiplexer MUX. The receiver and detector unit (receiver and detector) 280 may separate the multiplexed optical signals of multi-channel transmitted from the transmitter unit (transmitter) 260 and photoelectric-convert the separated optical signals to output the optical signals in the form of data input to the modulator unit (modulator) 240. For example, the receiver and detector unit (receiver and detector) 280 may include a demultiplexer DEMUX and may include one of the first to fifth light detector structures 100, 700, 800, 900, and 1000 described above. The separation of the multiplexed optical signals of the receiver and detector unit (receiver and detector) 280 into optical signals of multi-channel may include a process of first separation (selection) of the optical signals (wavelengths) at the first waveguide 110 by using the first resonator 120 and secondary separation (selection) of the first-separated optical signals (wavelengths) at the second waveguide 130 by using the second resonator 140, and the photoelectric conversion of the separated optical signals and output of the same in the form of the data input to the modulator unit 240 may include an operation of the photodiode PD included in the second resonator 140. The optical interconnect device 2200 may be formed as a chip.

The embodiments described above may be implemented in various forms as below.

A light detector structure according to one or more embodiments may include a first waveguide through which an optical signal is transmitted, a second waveguide arranged to be spaced apart from the first waveguide, a first resonator in a form of a ring which is arranged between a first side of the first waveguide and a first side of the second waveguide and has a first diameter, and a second resonator arranged on a second side of the second waveguide which is opposite to the first side of the second waveguide and having a second diameter which is less than the first diameter. The second waveguide may be arranged between the first resonator and the second resonator, and the second resonator may include a non-ring-type resonator.

The light detector structure may further include a first resonator array provided on the second side of the second waveguide. The first resonator array may include a plurality of non-ring-type resonators including the second resonator, and diameters of the plurality of non-ring-type resonators may be different from each other and may be less than the first diameter.

In the light detector structure according to one or more embodiments, the second resonator may include a disk-type resonator.

In the light detector structure according to one or more embodiments, the second resonator may include a substrate, a first semiconductor layer formed on the substrate, and a second semiconductor layer formed on the first semiconductor layer. The first semiconductor layer may include a first doping area, the second semiconductor layer may include a second doping area arranged to be spaced apart from the first doping area, and the entire second semiconductor layer may be on an area of the first semiconductor layer, which is placed inside of the first doping area, and a lateral side of the second semiconductor layer may be arranged to be spaced apart from the first doping area.

The light detector structure according to one or more embodiments may further include a third resonator arranged on a second side of the first waveguide, which is opposite to the first side of the first waveguide, and having a third diameter which is different from the first diameter and is greater than the second diameter.

The light detector structure may further include a third waveguide arranged on the second side of the first waveguide, and the third resonator may be arranged between the first waveguide and the third waveguide.

The light detector structure may further include a fourth resonator arranged adjacent to the third waveguide and having a fourth diameter which is less than the first diameter and the third diameter and is different from the second diameter.

The third waveguide may be arranged between the third resonator and the fourth resonator.

In the light detector structure according to one or more embodiments, a resonator array may be provided in a position of the fourth resonator of the third waveguide, the resonator array may include a plurality of resonators including the fourth resonator, and diameters of the plurality of resonators may be different from each other and may be less than the first diameter and the third diameter.

In the light detector structure according to one or more embodiments, a first ring-type resonator array may be arranged on one side of the first waveguide in a length direction of the first waveguide along the first waveguide, and the first ring-type resonator array may include a plurality of ring-type resonators of which diameters are different from each other and are greater than the second diameter.

In the light detector structure according to one or more embodiments, a plurality of second waveguides may be arranged in one-to-one correspondence to the plurality of ring-type resonators.

In the light detector structure according to one or more embodiments, a plurality of non-ring-type resonators which have a same structure as the second resonator and have diameters that are different from each other and are less than the diameters of the plurality of ring-type resonators may be arranged on the second side of the plurality of second waveguides.

In the light detector structure according to one or more embodiments, a non-ring-type resonator array may be arranged on the second side of each of the plurality of second waveguides, the non-ring-type resonator array may include a plurality of non-ring-type resonators having different diameters from each other, and the diameters of the plurality of non-ring-type resonators may be less than the diameters of the plurality of ring-type resonators.

In the light detector structure according to one or more embodiments, the plurality of second waveguides may be inclined with respect to the first waveguide.

In the light detector structure according to one or more embodiments, inclination angles of the plurality of second waveguides with respect to the first waveguide may be different from each other.

The light detector structure may further include a second ring-type resonator array arranged on a second side of the first waveguide, which is opposite to the first side of the first waveguide and arranged along the first waveguide in a length direction of the first waveguide. The second ring-type resonator array may include a plurality of ring-type resonators of which diameters are different from each other, are different from the first diameter, and are greater than the second diameter.

The light detector structure may further include a plurality of third waveguides arranged in one-to-one correspondence to a plurality of ring-type resonators included in the second ring-type resonator array, wherein the second ring-type resonator array may be arranged between the first waveguide and the plurality of third waveguides.

In the light detector structure according to one or more embodiments, the second ring-type resonator array may be provided on a first side of the plurality of third waveguides, a plurality of non-ring-type resonators may be further provided on a second side of the plurality of third waveguides, which is opposite to the first side of the plurality of third waveguides, and diameters of the plurality of non-ring-type resonators may be different diameters from each other and less than the diameters of the plurality of ring-type resonators included in the second ring-type resonator array.

In the light detector structure according to one or more embodiments, the second ring-type resonator array may be provided on a first side of the plurality of third waveguides, a plurality of non-ring-type resonators may be arranged on a second side of the plurality of third waveguides, which is opposite to the first side of the plurality of third waveguides, the non-ring-type resonator array may include a plurality of non-ring-type resonators having different diameters from each other, and the diameters of the plurality of non-ring-type resonators may be less than the diameters of the plurality of ring-type resonators included in the second ring-type resonator array.

In the light detector structure according to one or more embodiments, the plurality of third waveguides may be inclined with respect to the first waveguide.

In the light detector structure according to one or more embodiments, inclination angles of the plurality of third waveguides with respect to the first waveguide may be different from each other.

In the light detector structure according to one or more embodiments, the first waveguide and the second waveguide may respectively include parts which are parallel with each other, and the first resonator may be arranged between the parallel parts of the first waveguide and the second waveguide.

In the light detector structure according to one or more embodiments, the first waveguide and the second waveguide may be inclined with respect to each other.

In the light detector structure according to one or more embodiments, the first resonator and the second resonator may include the same material, and the second diameter may be less than or equal to ½ of the first diameter.

A manufacturing method of a light detector structure according to one or more embodiments my include forming a first resonator on a substrate and forming a waveguide through which an optical signal is transmitted in a position arranged to be spaced apart from the first resonator, and forming a second resonator on the substrate. The first resonator may be of a first type and may have a first diameter, a second resonator may be of a second type and may have a second diameter, the first type and the second type may be different from each other, the first diameter and the second diameter may be different from each other, and forming of the first resonator and the second resonator may be completed at different time points from each other.

In the manufacturing method according to one or more embodiments, the forming of the waveguide may include forming a first waveguide on the substrate, and forming a second waveguide arranged apart from the first waveguide. The first resonator may be formed between the first waveguide and the second waveguide, and the second waveguide may be arranged between the first resonator and the second resonator.

The manufacturing method may further include forming a plurality of first resonators along the first waveguide, wherein diameters of the plurality of first resonators are different from each other, forming a plurality of second waveguides to correspond to the plurality of first resonators, and forming a plurality of second resonators to correspond to the plurality of second waveguides. Diameters of the plurality of second resonators may be different from each other and may be less than the diameters of the plurality of first resonators.

The manufacturing method may further include forming a third waveguide on the substrate.

The manufacturing method may further include forming a third resonator on the substrate and between the first waveguide and the third waveguide. The third resonator may be of the first type and may have a third diameter which is different from the first diameter and is greater than the second diameter.

In the manufacturing method according to one or more embodiments, the first to third waveguides may respectively include parts which are parallel with each other, and the first to third resonators may be arranged between the parallel parts of the first to third waveguides.

In the manufacturing method according to one or more embodiments, at least one of the second and third waveguides may include a part inclined with respect to the first waveguide, and the first and third resonators may be arranged between the first waveguide and the inclined part of at least one of the second and third waveguides.

The manufacturing method may further include forming a fourth resonator on the substrate. The fourth resonator may be formed such that the third waveguide is located between the third resonator and the fourth resonator, and the fourth resonator may be of the second type and may have a fourth diameter which is different from the second diameter and is less than the first diameter and the third diameter.

The manufacturing method may further include forming a plurality of third resonators along the first waveguide, wherein diameters of the plurality of third resonators are different from each other, forming a plurality of third waveguides to correspond to the plurality of third resonators, and forming a plurality of fourth resonators to correspond to the plurality of third waveguides. Diameters of the plurality of fourth resonators may be different from each other and may be less than the diameters of the plurality of third resonators.

In the manufacturing method according to one or more embodiments, a plane shape of the first resonator may be a ring shape, and a plane shape of the second resonator may be a disk shape.

In the manufacturing method according to one or more embodiments, the second diameter may be less than or equal to ½ of the first diameter.

In the manufacturing method according to one or more embodiments, the forming of the second resonator may include forming a first semiconductor layer on the substrate, forming a first doping area in a first area of the first semiconductor layer, forming a second semiconductor layer in a second area of the first semiconductor layer, which is arranged to be spaced apart from the first area of the first semiconductor layer, and forming a second doping area in the second semiconductor layer. One of the first doping area and the second doping area may be an area into which a P-type dopant is injected, and the other may be an area into which an N-type dopant is injected.

An optical interconnect device according to one or more embodiments may include a light source unit, a modulator unit including a component configured to modulate light emitted from the light source unit, a transmitter unit configured to transmit modulated light transmitted from the modulator unit, and a receiver and detector unit including a component configured to receive and detect light transmitted from the transmitter unit. The receiver and detector unit may include a light detector structure, the light detector structure may include a first waveguide through which an optical signal is transmitted, a second waveguide arranged to be spaced apart from the first waveguide, a first resonator in a form of a ring which is arranged between a first side of the first waveguide and a first side of the second waveguide and has a first diameter, and a second resonator arranged on a second side of the second waveguide which is opposite to the first side of the second waveguide and having a second diameter which is less than the first diameter. The second waveguide may be arranged between the first resonator and the second resonator, and the second resonator may include a disk-type resonator.

In the optical interconnect device, the light detector structure may first use the ring-type resonators having a large diameter to detect optical signals (for example, wavelengths) transmitted to the waveguide and later to filter the optical signals, and then use the disk-type resonators having a relatively small diameter to perform secondary filtering of the optical signals transmitted through the ring-type resonators. The diameter of the ring-type resonator may be greater than the diameter of the disk-type resonator and may be at least twice as great as the diameter of the disk-type resonator. Accordingly, the FSR of the disk-type resonator may be at least twice as great as the FSR of the ring-type resonator. In addition, the disk-type resonator may include an infrared absorption layer and a photodiode PD linked to the resonator. For example, as the disk-type resonator may be coupled and linked to the photodiode PD, the detection and filtering of the optical signals may be performed simultaneously.

The two-stage resonator structure, which combines ring-type and disk-type resonators, enables precise wavelength filtering. In the first stage, fine filtering of narrow-band signals is performed, while the second stage selectively extracts and converts the filtered signals over a broader wavelength range into electrical signals. As a result, this two-stage design supports efficient spectral measurement and enhances data throughput.

Accordingly, by using the light detector structure described above, the optical signals (for example, wavelengths) of wideband may be more accurately received and more easily detected. As the optical signal corresponds to the data (information) input to the optical interconnect device, the light detector structure according to the disclosure may facilitate accurate processing of information of wide wavelength band (multi-channel information). In addition, as the disk-type resonator is coupled to the photodiode PD linked to the operations to operations of the resonator, a separate light detector does not need to be formed for detection of optical components selected by the resonator, and issues concerning the coupling of the light detector and the resonator may be overcome.

Furthermore, by using the disk-type resonator for secondary filtering, the process may be more simplified, and the process margin may increase in comparison with the case where the ring-type resonator is used.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. A light detector structure comprising:
a first waveguide configured to transmit an optical signal;
a second waveguide spaced apart from the first waveguide;
a first resonator between a first side of the first waveguide and a first side of the second waveguide, the first resonator having a ring shape and a first diameter; and
a second resonator on a second side of the second waveguide opposite to the first side of the second waveguide, the second resonator having a second diameter which is less than the first diameter,
wherein the second waveguide is between the first resonator and the second resonator, and
wherein the second resonator comprises a non-ring-type resonator.

2. The light detector structure of claim 1, further comprising a first resonator array on the second side of the second waveguide,
wherein the first resonator array comprises a plurality of non-ring-type resonators comprising the second resonator, and
wherein diameters of the plurality of non-ring-type resonators are different from each other and are less than the first diameter.

3. The light detector structure of claim 1, wherein the second resonator comprises a disk-type resonator.

4. The light detector structure of claim 3, wherein the second resonator comprises:
a substrate;
a first semiconductor layer on the substrate; and
a second semiconductor layer on the first semiconductor layer,
wherein the first semiconductor layer comprises a first doping area,
wherein the second semiconductor layer comprises a second doping area spaced apart from the first doping area, and
wherein an entirety of the second semiconductor layer is on an area of the first semiconductor layer inside of the first doping area, and a lateral side of the second semiconductor layer is spaced apart from the first doping area.

5. The light detector structure of claim 1, further comprising:
a third resonator on a second side of the first waveguide opposite to the first side of the first waveguide, the third resonator having a third diameter which is different from the first diameter and is greater than the second diameter;
a third waveguide on the second side of the first waveguide; and
a fourth resonator adjacent to the third waveguide and having a fourth diameter which is less than the first diameter and the third diameter and is different from the second diameter,
wherein the third resonator is between the first waveguide and the third waveguide, and
wherein the third waveguide is between the third resonator and the fourth resonator.

6. The light detector structure of claim 5, wherein a resonator array is adjacent to the third waveguide,
wherein the resonator array comprises a plurality of resonators comprising the fourth resonator, and
wherein diameters of the plurality of resonators are different from each other and are less than the first diameter and the third diameter.

7. The light detector structure of claim 1, wherein a first ring-type resonator array is on the first side of the first waveguide along a length direction of the first waveguide,
wherein the first ring-type resonator array comprises a plurality of ring-type resonators having diameters that are different from each other and are greater than the second diameter, and
wherein a plurality of second waveguides, comprising the second waveguide, are in one-to-one correspondence to the plurality of ring-type resonators.

8. The light detector structure of claim 7, wherein a non-ring-type resonator array is on the second side of each of the plurality of second waveguides,
wherein the non-ring-type resonator array comprises a plurality of non-ring-type resonators having a structure same as a structure of the second resonator and diameters that are different from each other and
less than the diameters of the plurality of ring-type resonators included in the first ring-type resonator array.

9. The light detector structure of claim 7, wherein the plurality of second waveguides are inclined with respect to the first waveguide.

10. The light detector structure of claim 7, further comprising:
a second ring-type resonator array on a second side of the first waveguide opposite to the first side of the first waveguide, the second ring-type resonator array being along the length direction of the first waveguide;
a plurality of third waveguides in one-to-one correspondence to a plurality of ring-type resonators included in the second ring-type resonator array; and
a plurality of non-ring-type resonators in correspondence to the plurality of third waveguides,
wherein the plurality of ring-type resonators included in the second ring-type resonator array have diameters that are different from each other, are different from the first diameter, and are greater than the second diameter,
wherein the second ring-type resonator array is between the first waveguide and the plurality of third waveguides, and
wherein the plurality of third waveguides are between the second ring-type resonator array and the plurality of non-ring-type resonators.

11. The light detector structure of claim 10, wherein diameters of the plurality of non-ring-type resonators are different from each other and are less than the diameters of the plurality of ring-type resonators included in the second ring-type resonator array.

12. The light detector structure of claim 10, wherein the plurality of third waveguides are inclined with respect to the first waveguide.

13. A method of manufacturing a light detector structure, the method comprising:
forming a first resonator on a substrate;
forming a waveguide, configured to transmit an optical signal, spaced apart from the first resonator; and
forming a second resonator on the substrate,
wherein the first resonator is of a first type and has a first diameter,
wherein the second resonator is of a second type and has a second diameter,
wherein the first type and the second type are different from each other,
wherein the first diameter and the second diameter are different from each other, and
wherein the forming of the first resonator and the forming of the second resonator are completed at different time points from each other.

14. The method of claim 13, wherein the forming of the waveguide comprises:
forming a first waveguide on the substrate; and
forming a second waveguide spaced apart from the first waveguide,
wherein the first resonator is formed between the first waveguide and the second waveguide, and
wherein the second waveguide is formed between the first resonator and the second resonator.

15. The method of claim 14, further comprising:
forming a plurality of first resonators, comprising the first resonator, along the first waveguide, diameters of the plurality of first resonators being different from each other;
forming a plurality of second waveguides, comprising the second waveguide, to correspond to the plurality of first resonators, respectively; and
forming a plurality of second resonators, comprising the second resonator, to correspond to the plurality of second waveguides, respectively,
wherein diameters of the plurality of second resonators are different from each other and are less than the diameters of the plurality of first resonators.

16. The method of claim 14, further comprising:
forming a third waveguide on the substrate; and
forming a third resonator on the substrate which is between the first waveguide and the third waveguide,
wherein the third resonator is of the first type and has a third diameter which is different from the first diameter and is greater than the second diameter.

17. The method of claim 16, further comprising forming a fourth resonator on the substrate,
wherein the fourth resonator is formed such that the third waveguide is between the third resonator and the fourth resonator, and
wherein the fourth resonator is of the second type and has a fourth diameter which is different from the second diameter and is less than the first diameter and the third diameter.

18. The method of claim 17, further comprising:
forming a plurality of third resonators, comprising the third resonator, along the first waveguide, diameters of the plurality of third resonators being different from each other;
forming a plurality of third waveguides, comprising the third waveguide, to correspond to the plurality of third resonators, respectively; and
forming a plurality of fourth resonators, comprising the fourth resonator, to correspond to the plurality of third waveguides, respectively,
wherein diameters of the plurality of fourth resonators are different from each other and are less than the diameters of the plurality of third resonators.

19. The method of claim 13, wherein the forming of the second resonator comprises:
forming a first semiconductor layer on the substrate;
forming a first doping area in a first area of the first semiconductor layer;
forming a second semiconductor layer in a second area of the first semiconductor layer spaced apart from the first area of the first semiconductor layer; and
forming a second doping area in the second semiconductor layer,
wherein one of the first doping area and the second doping area comprises a P-type dopant, and the other of the first doping area and the second doping area comprises an N-type dopant.

20. An optical interconnect device comprising:
a light source;
a modulator configured to modulate light emitted from the light source;
a transmitter configured to transmit the modulated light transmitted from the modulator;
a receiver and detector configured to receive and detect the light transmitted from the transmitter,
wherein the receiver and detector comprise a light detector structure comprising:
a first waveguide configured to transmit an optical signal;
a second waveguide spaced apart from the first waveguide;
a first resonator between a first side of the first waveguide and a first side of the second waveguide, the first resonator having a ring shape and a first diameter; and
a second resonator on a second side of the second waveguide opposite to the first side of the second waveguide, the second resonator having a second diameter which is less than the first diameter, and
wherein the second waveguide is between the first resonator and the second resonator, and
wherein the second resonator comprises a disk-type resonator.
